(19) United States
(12) Patent Application Publication
(10) Pub. No.: US 2008/0047022 A1
(43) Pub. Date: Feb. 21, 2008

(54) STAND-ALONE, DEDICATED DEVICE FOR SAFELY SELECTING HOST INTERFACE PORTS TO CONTROL A LONG-TERM STORAGE DEVICE

(76) Inventors: Steven Bress, Germantown, MD (US); Mark Menz, Folsom, CA (US)

Correspondence Address: Steven Bress, 17917 Wheatridge Drive, Germantown, MD, 20874, US

(21) Appl. No.: 11/842,082

(22) Filed: Aug. 20, 2007

Related U.S. Application Data
(60) Provisional application No. 60/822,962, filed on Aug. 21, 2006.

(51) Int. Cl. H04L 9/32

(52) U.S. Cl. 726/29

(57) ABSTRACT

There is a need for law enforcement officials to examine the contents of long-term storage devices, such as hard drives. This includes even hard drives that are part of video game systems, such as Microsoft's Xbox. The hard drive on an Xbox is password protected or “locked”, making examination time consuming, as the password has to be “cracked”. However, upon the Xbox being powered up, the Xbox unlocks its drive. The present invention makes use of this feature and teaches systems and methods of allowing the Xbox (and similar devices) to unlock their drives, and then switching control of the drive to a second host.

### FIELD OF THE INVENTION

The present invention relates to computer memory devices and, more specifically, to mechanisms for unlocking computer memory devices and subsequently selecting from a plurality of host interface ports.

### BACKGROUND OF THE INVENTION

There is a need for law enforcement officials to examine the contents of long-term storage devices, such as hard drives. Any long-term storage device may contain illegal content. This includes such devices as video game consoles.

In some cases, a hard drive is password protected and the password is unavailable to the investigating officer. Without the proper password, data stored on the hard drive cannot be read. Cracking a password can be a very time consuming processes ranging from days to months.

In some cases, a computer system has or generates a password to unlock a drive. One such device, is the Xbox® Video Gaming Device (host) manufactured by Microsoft Corporation of Redmond, Wash. The Xbox attempts to unlock its drive when a user turns it on. If the password generated by the Xbox is not accepted by the drive an error code is returned and the Xbox assumes that something is wrong with the drive, and issues the user an error message. It is thought that this password is generated on-the-fly by looking at the Xbox's unique serial number, configuration, revision level and information obtained from the currently installed hard drive. Microsoft may use this system as a means to deter users from substituting hard drives.

A drive unlocked in such a fashion is not in a state that it can be safely examined using industry standard computer forensics tools. One option would be to keep the drive under power in the Xbox (host) so it would remain in an unlocked state, disconnect the drive cable from the Xbox and then connect the drive cable to a forensics computer. As drives are not designed to be “hot swapped” in such a manner this, could result in the destruction of the drive's electronics and possibly changing the state of data on the drive. This is not acceptable for computer forensics work.

Accordingly, there is a need in the art for a mechanism to allow a host (such as an Xbox) to unlock an associated long-term storage device in such a manner that the long-term storage device can be accessed by standard computer forensic tools. One knowledgeable in the art would understand that although the discussion uses the Xbox as a specific example, our present invention is not limited to the Xbox and that our present invention is suitable for any device that unlocks its associated long-term memory component.

### SUMMARY OF THE INVENTION

The present invention (DriveSwitch) is a stand-alone, dedicated device 1 00. With a host powered down, the data cable to the long-term memory component is removed from the host. Our current invention 1 00 is connected to a host 200 through connection 230, to a drive 220 through connection 250 and to a computer forensic device 210 through connection 240. Our present invention 1 00 opens a path from the host 200 to the drive 220 to enable the host unlock the drive. When the drive has been unlocked, our present invention opens a path from the drive 220 to the Computer Forensic Device 210 and closes the path from host 200 to drive 220.

In another embodiment, logic and circuitry monitor commands issued by a host to the storage device. Once the command to unlock the drive has been issued by the host and the proper response received, the present invention would automatically open a path from the storage device to the forensic device and close a path from the storage device to the host. This embodiment would ensure that the host would not make any changes to the data in the storage device.

In another embodiment the logic and circuitry watches for the host to issue a “write to command register”, then waits a pre-determined amount of time then performs a switch.

In another embodiment the logic and circuitry watches for the host to issue a “write to command”, then substitutes a fake command, and then performs a switch.

In another embodiment the logic and circuitry watches for the host to issue a disable password command to the drive and then performs a switch.

In a further embodiment the logic and circuitry watches for the drive to return a successful password disabled status to the host and then performs a switch.

In another embodiment a user controlled mechanical switch changes the path from the host to the computer forensic device.

In a further embodiment a signal from the forensic device changes the path from the host to the computer forensic device.

In another embodiment a user controlled switch signals the logic and circuitry to switch from the host to the computer forensic device.

In a further embodiment, when a mechanical switch is used to provide user input, the current invention uses an electronic “debouncing” circuit to take the irregular input from the switch and provide a clean signal.

In another embodiment the device displays which path is open to a user by a method such as Light Emitting Diodes (LED).

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 is a block diagram of the current invention;

FIG. 2 is a simplified block diagram of the current invention.

### DETAILED DESCRIPTION

The following detailed description of implementations consistent with the present invention refers to the accompanying drawings. The same reference numbers in different drawings identify the same or similar elements. Also, the following detailed description does not limit the invention. Instead the scope of the invention is defined by the appended claims and equivalents.

Systems and methods consistent with the present invention provide mechanisms through which control of a long-term storage device, such as a hard drive, is switched between a plurality of hosts. In particular, a determination is made that the original host has “unlocked” a storage device and then control of the storage device is switched to a second host.

### Detailed Description

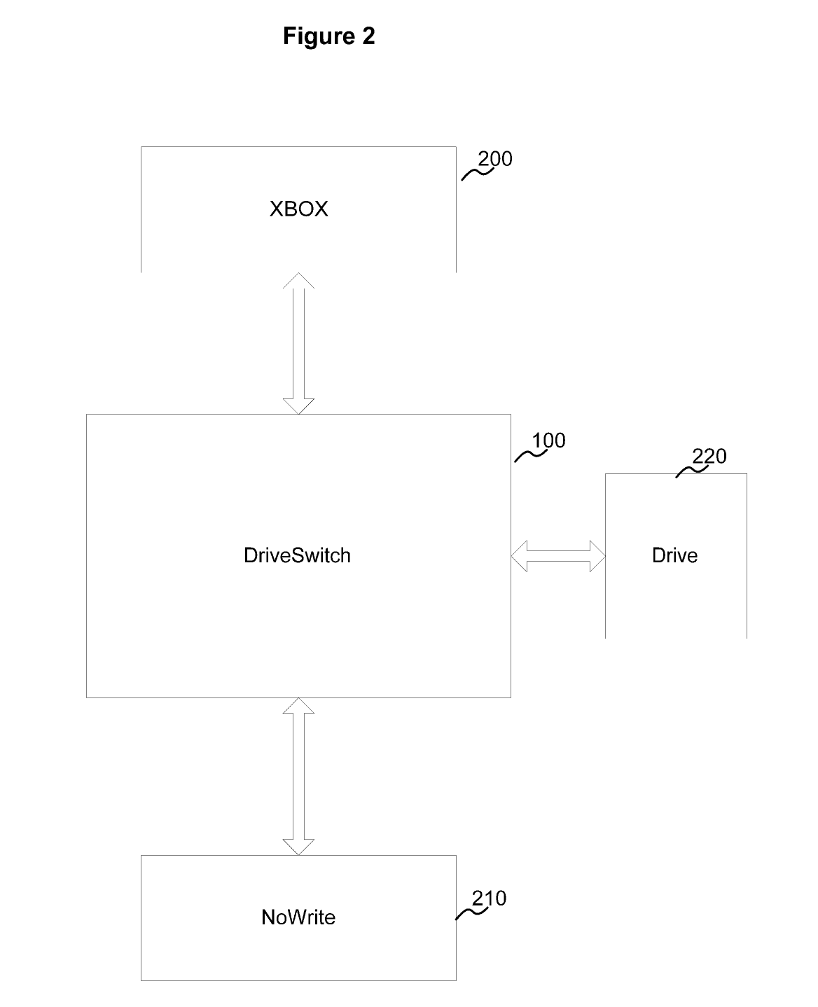

FIG. 2 shows an overview of the present device 1 00. The device has three primary interface connectors. Interface connector 120 connects the device to the original host/Xbox 200. The drive from the original host/Xbox 220 is connected to the device by interface connector 105. A computer forensic device, such as a write-blocking device (U.S. Pat. No. 6,813,682) 210 connected to a computer is connected to the present device through interface connector 130. One skilled in the art would understand that this discussion teaches the essentials to building a stand-alone, dedicated device for safely selecting host interface ports to control a long-term storage. Details such as the fact that electronic components require a power supply are understood by one skilled in the art and so not covered here.

For ease of discussion the interfaces connecting the drive are industry standard IDE interfaces. One skilled in the art would understand that the principles taught here can be used for other interfaces, such as SATA. Additionally, one skilled in the art would understand that not all interfaces have to be of a similar type. For example, 120 and 105 could be an IDE interface while 130 could be a SATA interface.

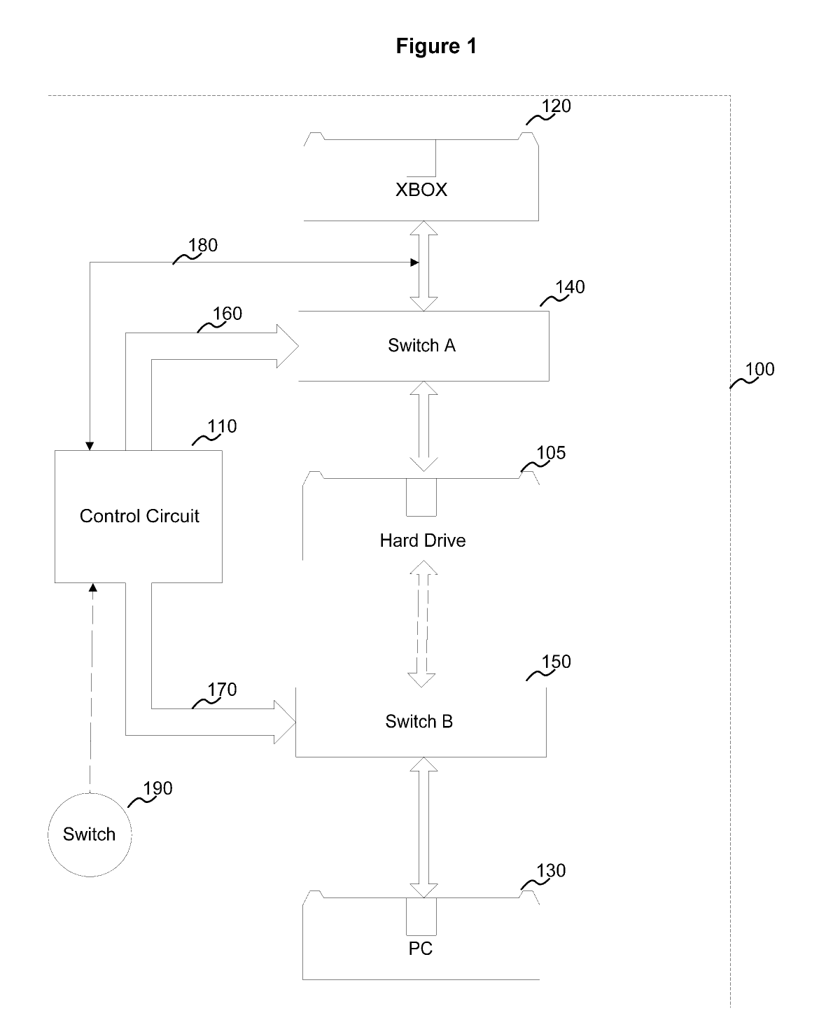

Referring to FIG. 1. The Xbox/original drive is plugged into connector 105. The Xbox/original host is plugged into connector 120. The Forensic Device/second host (which may be a computer protected by a write-blocking device) is plugged into connector 130. The write-blocking device is to prevent any changes being made to the data of the hard drive, which is important in computer forensic work.

Switch A 140 and Switch B 150 may be comprised of CMOS Bus Switches, such as Integrated Device Technology's (IDT) IDTQS316211 24-Bit Bus Switch. Devices such as CMOS Bus Switches can isolate or connect data lines. In our device Control Circuit 110 controls these switches.

Control Circuit 110 may be comprised of a microcontroller, such as Microchip's 16LF88, with integrated FLASH, RAM and oscillator. In broad terms, the Control Circuit monitors the activity of the Xbox/original host to determine when the drive has been unlocked, and once the drive is unlocked to switch from the Xbox/original host to the forensic device/second host. There are a number of different embodiments possible to determine when the drive is unlocked and a switch may be made to the forensic device/second host.

In one embodiment, control lines 180 from the Xbox interface are connected to the Control Circuit 110. This allows the Control Circuit to determine when it is safe to switch control from one input to the other. For example, the Control Circuit can set a delay sufficient to allow the command to complete. In this way, the Control Circuit can insure that there are no pending commands that will need to be cleared after control is switched.

In another embodiment, the Control Circuit can monitor commands issued to the drive by the Xbox/original host. Once a command has been issued to unlock the drive, and the drive has provided the proper response the Control Circuit may automatically switch from Xbox/original host to forensic device/second host. This would have an additional benefit of insuring that the original host did not make any changes to the data on the drive after unlocking it.

In another embodiment, the Control Circuit performs a switch upon detecting a disable password command. The Control Circuit may insert a pre-determined delay between the detection of the disable password command and the switch.

In another embodiment, the Control Circuit performs a switch after detecting a write to command. The Control Circuit may insert a pre-determined delay between the detection of the write to command and the switch.

In a further embodiment of the above, the Control Circuit may substitute a “fake” command for the write to command from the Xbox/original host, and then perform a switch.

In another embodiment, a switch 190 is provided to provide user input. With this switch a user may specific or change whether the Xbox/original host or Forensic Device/second host is connected to the hard drive. That is, Switch 190 indicates to Control Circuit 110 whether to enable Switch A 140 and disable Switch B 150, or vice versa.

In a further embodiment, when a mechanical switch is used additional electronic “debouncing” circuitry is also used to take the irregular input from a mechanical switch and provide a clean signal.

In another embodiment feedback is provided to a user as to the state of the switches. This may be done by using Light Emitting Diodes (LED) among other methods.

The foregoing description of preferred embodiments of the present invention provides illustration and description, but is not intended to be exhaustive or to limit the invention to the precise form disclosed. Modifications and variations are possible in light of the above teachings or may be acquired from practice of the invention. For example, systems and methods are discussed above in relation to an Xbox, the same teachings may be applied to similar devices such as an Xbox 360.

The following claims and their equivalents define the scope of the invention.

What is claimed is:

1. A dedicated, stand-alone switching device comprising:
an interface for connecting to a host (original); and
an interface for connecting to a second host (forensic); and
an interface for connecting to a storage device (storage); and
logic and circuitry coupled to the interfaces, the logic and circuitry determining when the storage device has been put into an unlocked state and then switching from the host (original) controlling the storage device to the second host (forensic) controlling the storage device, wherein the switching device is transparent to the normal operation of the original host's operating system and second host's operating systems.

2. The dedicated, stand-alone switching device of claim 1 wherein a mechanical switch is used to indicate to the switching device that a switch is desired.

3. The dedicated, stand-alone switching device of claim 1 further comprising a user interface (such as Light Emitting Diodes) to indicate to a user whether the original host or the forensic host is controlling the storage device.

4. The dedicated, stand-alone switching device of claim 1 wherein the logic and circuitry insure there are no pending commands issued from original host that would need to be cleared before switching to forensic host.

5. The dedicated, stand-alone switching device of claim 1 wherein the logic and circuitry monitor commands issued by the original host and when a disable password command is detected switches from the original host to the forensic host.

6. The dedicated, stand-alone switching device of claim 5 wherein the logic and circuitry insert a pre-determined delay after detecting a disable password command.

7. The dedicated, stand-alone switching device of claim 1 wherein the logic and circuitry monitor commands issued by the original host and when a “write to” command is detected switches from the original host to the forensic host.

8. The dedicated, stand-alone switching device of claim 7 wherein the logic and circuitry insert a pre-determined delay after detecting a “write-to” command.

9. The dedicated, stand-alone switching device of claim 7 wherein the logic and circuitry discard the “write-to” command and a “fake” command is substituted.

10. The dedicated, stand-alone switching device of claim 1 further comprising a physical switch to accept user input.

11. The dedicated, stand-alone switching device of claim 10 wherein the logic and circuitry switches between original host and forensic host depending on the physical switch setting.

12. The dedicated, stand-alone switching device of claim 10 further comprising “debouncing” circuitry to provide a clean signal from the physical switch to the logic and circuitry.

13. The dedicated, stand-alone switching device of claim 10 further comprising a user interface (such as light emitting diodes) to indicate the state of the switch.
